(19) United States
(12) Patent Application Publication
(10) Pub. No.: US 2023/0397249 A1
(43) Pub. Date: Dec. 7, 2023

(54) PREEMPTION FOR LOW-LATENCY TRAFFIC DURING A TXOP USING A PREEMPTION REQUEST CONTROL FRAME

(71) Applicants: Juan Fang, Portland, OR (US); Qinghua Li, San Ramon, CA (US); Robert J. Stacey, Portland, OR (US); Laurent Cariou, Milizac (FR); Hao Song, Santa Clara, CA (US)

(72) Inventors: Juan Fang, Portland, OR (US); Qinghua Li, San Ramon, CA (US); Robert J. Stacey, Portland, OR (US); Laurent Cariou, Milizac (FR); Hao Song, Santa Clara, CA (US)

(21) Appl. No.: 18/235,524

(22) Filed: Aug. 18, 2023

(51) Int. Cl. H04W 74/08

(52) U.S. Cl. CPC H04W 74/0808; H04W 84/12

(57) ABSTRACT

An access point station (AP) configured for ultra-high reliability (UHR) communication in a wireless local area network (WLAN) may receive low-latency (i.e., time-sensitive) traffic during a transmission opportunity (TXOP) by transmission of an initial frame encoded to indicate whether or not preemption for low-latency (LL) traffic is enabled during the TXOP. When preemption for LL traffic is enabled during the TXOP, the AP may encode downlink (DL) physical-layer protocol data units (PPDUs) for transmission within the TXOP. The DL PPDUs may be transmitted with an extended short interframe spacing (xIFS) therebetween. Each of the DL PPDUs may indicate whether the xIFS that follows a DL PPDU is enabled for preemption. When a signal comprising at least a legacy short-training field (L-STF) is detected within one of the xIFSs that is enabled for preemption, the AP may suspend a subsequent transmission of at least the next DL PPDU and may attempt to decode a frame that comprises the L-STF to determine if the frame is a preemption request frame. The AP may trigger a station (STA) to transmit LL traffic to the AP when the frame is determined to be a preemption request frame.

### BACKGROUND

Communicating time-sensitive traffic, sometimes referred to as low-latency (LL) traffic is a challenge for wireless local area networks (WLANs) for many reasons. For example, contention for the wireless medium since WLANs typically use a shared medium for all clients, there can be contention that introduces jitter and latency when multiple clients try to communicate simultaneously. This is especially problematic for time-sensitive traffic like voice and video. Hidden node problem (i.e., when nodes are out of range of each other but in range of an access point, they cannot sense when the other is transmitting) can lead to collisions and retransmissions that disrupt low-latency communications. Channel errors and retransmissions (i.e., the wireless medium is subject to interference and noise, which can corrupt packets and force retransmission) adds latency and jitter. Packet loss (i.e., dropped or corrupted packets require retransmission) adds latency and time-sensitive traffic like voice and video may not be able to wait for retransmissions. Overloaded network (i.e., too many clients contending for bandwidth on a WLAN) can make it difficult to provide consistent low-latency service, especially for bandwidth-heavy traffic like video. Roaming between APs (i.e., when a client roams between APs) can introduce latency while the network reconnects the client to the new AP. Power save operations (i.e., some power save mechanisms like PS-Poll) can add significant latency for individual packet transmissions.

Thus, there are general needs for improving LL communications in a WLAN.

### BRIEF DESCRIPTION OF THE DRAWINGS

FIG. 1 is a block diagram of a radio architecture, in accordance with some embodiments.

FIG. 2 illustrates a front-end module circuitry for use in the radio architecture of FIG. 1, in accordance with some embodiments.

FIG. 3 illustrates a radio IC circuitry for use in the radio architecture of FIG. 1, in accordance with some embodiments.

FIG. 4 illustrates a baseband processing circuitry for use in the radio architecture of FIG. 1, in accordance with some embodiments.

FIG. 5 illustrates a WLAN, in accordance with some embodiments.

FIG. 6 illustrates preemption for low-latency (LL) traffic during a transmission opportunity (TXOP), in accordance with some embodiments.

FIG. 7A illustrates a preemption request control frame, in accordance with some embodiments.

FIG. 7B illustrates a preemption request control frame, in accordance with some other embodiments.

FIG. 7C illustrates Short Feedback MAC frame format for a preemption request frame, in accordance with some embodiments.

FIG. 7D illustrates frame control and feedback time fields, in accordance with some embodiments.

FIG. 8 illustrates a wireless communication device, in accordance with some embodiments.

FIG. 9 is a procedure for reception of low-latency (LL) traffic by an access point station (AP) configured for ultra-high reliability (UHR) communication in a wireless local area network (WLAN), in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Embodiments described herein are directed to an access point station (AP) configured for ultra-high reliability (UHR) communication in a wireless local area network (WLAN) that may receive low-latency (i.e., time-sensitive) traffic during a transmission opportunity (TXOP) by transmission of an initial frame encoded to indicate whether or not preemption for low-latency (LL) traffic is enabled during the TXOP. When preemption for LL traffic is enabled during the TXOP, the AP may encode downlink (DL) physical-layer protocol data units (PPDUs) for transmission within the TXOP. The DL PPDUs may be transmitted with an extended short interframe spacing (xIFS) therebetween. Each of the DL PPDUs may indicate whether the xIFS that follows a DL PPDU is enabled for preemption. When a signal comprising at least a legacy short-training field (L-STF) is detected within one of the xIFSs that is enabled for preemption, the AP may suspend a subsequent transmission of at least the next DL PPDU and may attempt to decode a frame that comprises the L-STF to determine if the frame is a preemption request frame. The AP may trigger a station (STA) to transmit LL traffic to the AP when the frame is determined to be a preemption request frame. These embodiments as well as others, are described in more detail herein.

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM CIRCUITRY 104A and FEM CIRCUITRY 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM CIRCUITRY 104A or 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or integrated circuit (IC), such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal sub carriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, IEEE 802.11ax, and/or IEEE P802.11be standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In some embodiments, the radio architecture 100 may be configured for Extremely High Throughput (EHT) communications in accordance with the IEEE 802.11be standard. In some embodiments, the radio architecture 100 may be configured for Ultra-High Reliability (UHR) communications in accordance with a IEEE 802.11 (e.g., WiFi 8). In these embodiments, the radio architecture 100 may be configured to communicate in accordance with an OFDMA technique, although the scope of the embodiments is not limited in this respect. In some embodiments, the radio architecture 100 may be configured for next generation vehicle-to-everything (NGV) communications in accordance with the IEEE 802.11bd standard and one or more stations including AP 502 may be next generation vehicle-to-everything (NGV) stations (STAs).

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards.

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5MHz, 8 MHz, 10 MHz, 16 MHz, 20 MHz, 40MHz, 80MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

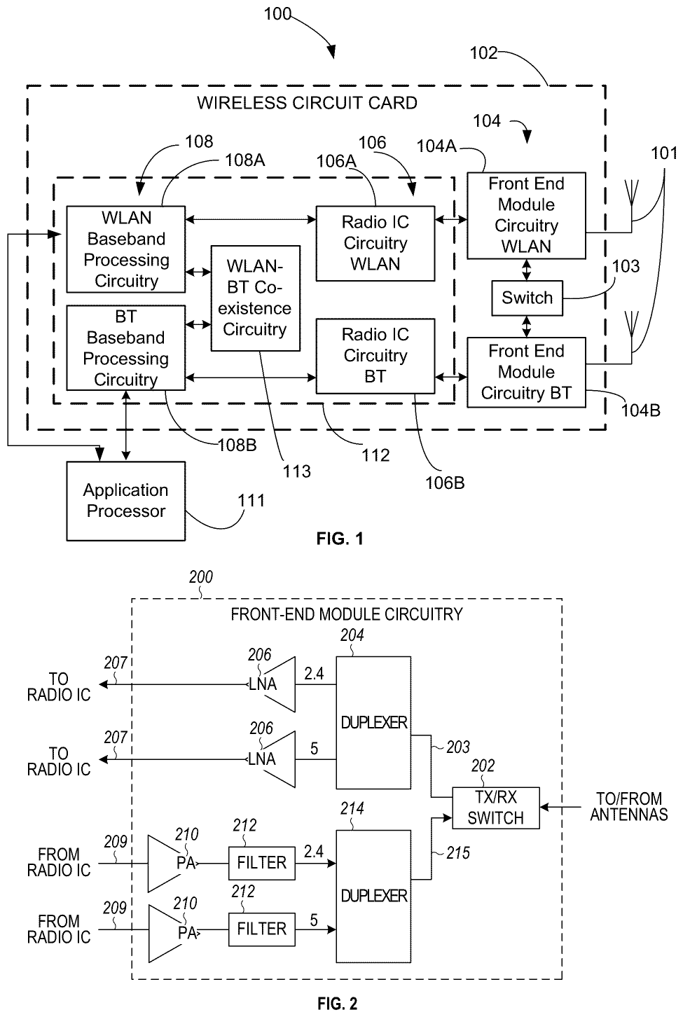

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

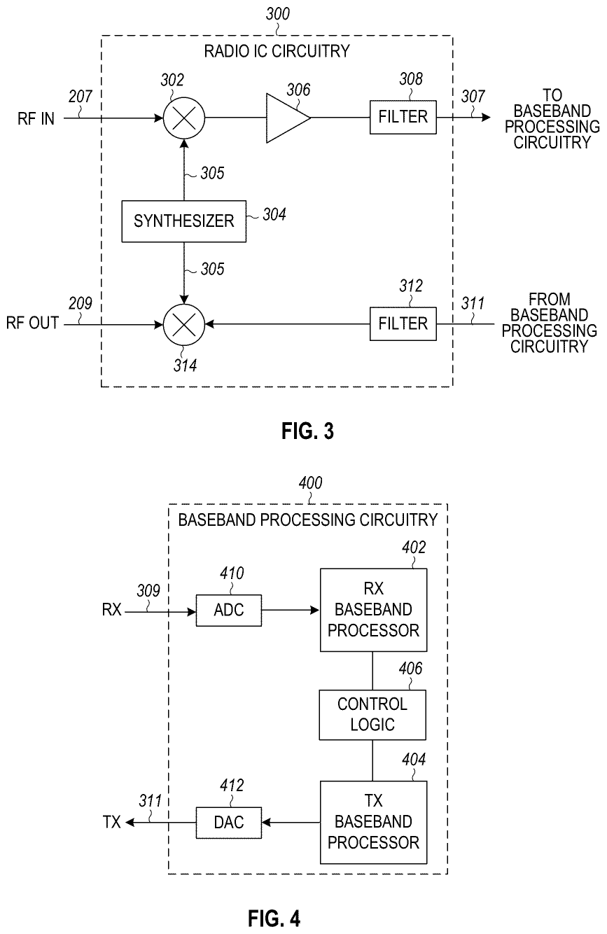

FIG. 3 illustrates radio IC circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional−N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 304 may be provided by a voltage controlled oscillator (VCO), although that is not a requirement. A divider control input may further be provided by either the baseband processing circuitry 108 (FIG. 1) or application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processor 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

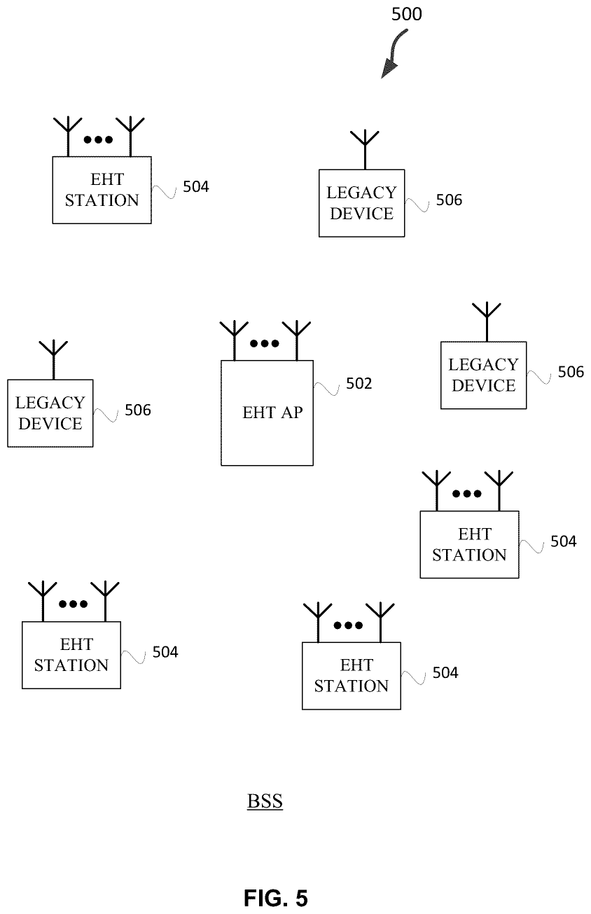

FIG. 5 illustrates a WLAN 500 in accordance with some embodiments. The WLAN 500 may comprise a basis service set (BSS) that may include an access point (AP) 502, which may be an AP, a plurality of stations 504, and a plurality of legacy (e.g., IEEE 802.11n/ac/ax) devices 506. In some embodiments, WLAN 500 may be configured for Extremely High Throughput (EHT) communications in accordance with the IEEE 802.11be standard and one or more stations including AP 502 and stations 504 may be EHT STAs. In some embodiments, WLAN 500 may be configured for Ultra-High Rate (UHR) communications in accordance with one of the IEEE 802.11 standards or draft standards and one or more stations including AP 502 and stations 504 may be UHR and/or UHR+STAs.

In some embodiments, WLAN 500 may be configured for next generation vehicle-to-everything (NGV) communications in accordance with the IEEE 802.11bd standard and one or more stations including AP 502 may be next generation vehicle-to-everything (NGV) stations (STAs).

The AP 502 may be an AP using the IEEE 802.11 to transmit and receive. The AP 502 may be a base station. The AP 502 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502.

The legacy devices 506 may operate in accordance with one or more of IEEE 802.11 a/b/g/n/ac/ad/af/ah/aj/ay, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the STAs 504 may be termed high efficiency (HE) stations.

AP 502 may communicate with legacy devices 506 in accordance with legacy IEEE 802.11 communication techniques. In example embodiments, AP 502 may also be configured to communicate with STAs 504 in accordance with legacy IEEE 802.11 communication techniques.

In some embodiments, a frame may be configurable to have the same bandwidth as a channel. The frame may be a physical Layer Convergence Procedure (PLCP) Protocol Data Unit (PPDU). In some embodiments, there may be several types of PPDUs that may have different fields and different physical layers and/or different media access control (MAC) layers.

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA PPDU formats. In some embodiments, the 106-subcarrier RU is used in the 20 MHz, 40 MHz, 80 MHz, 160 MHz and 80+80 MHz OFDMA and MU-MIMO PPDU formats. In some embodiments, the 242-subcarrier RU is used in the 40 MHz, 80 MHz, 160 MHz and 80+80 MHz OFDMA and MU-MIMO PPDU formats. In some embodiments, the 484-subcarrier RU is used in the 80 MHz, 160 MHz and 80+80 MHz OFDMA and MU-MIMO PPDU formats. In some embodiments, the 996-subcarrier RU is used in the 160 MHz and 80+80 MHz OFDMA and MU-MIMO PPDU formats.

A frame may be configured for transmitting a number of spatial streams, which may be in accordance with MU-MIMO and may be in accordance with OFDMA. In other embodiments, AP 502, STA 504, and/or legacy device 506 may also implement different technologies such as code division multiple access (CDMA) 2000, CDMA 2000 1X, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE and/or EHT communications. In accordance with some IEEE 802.11 embodiments (e.g., IEEE 802.11ax embodiments) a AP 502 may operate as a primary station which may be arranged to contend for a wireless medium (e.g., during a contention period) to receive exclusive control of the medium for an control period. In some embodiments, the control period may be termed a transmission opportunity (TXOP). AP 502 may transmit a master-sync transmission, which may be a trigger frame or control and schedule transmission, at the beginning of the control period. AP 502 may transmit a time duration of TXOP and sub-channel information. During the control period, STAs 504 may communicate with AP 502 in accordance with a non-contention based multiple access technique such as OFDMA or MU-MIMO. This is unlike conventional WLAN communications in which devices communicate in accordance with a contention-based communication technique, rather than a multiple access technique. During the control period, the AP 502 may communicate with STAs 504 using one or more frames. During the control period, the STAs 504 may operate on a sub-channel smaller than the operating range of the AP 502. During the control period, legacy stations refrain from communicating. The legacy stations may need to receive the communication from the AP 502 to defer from communicating.

In accordance with some embodiments, during TXOP the STAs 504 may contend for the wireless medium with the legacy devices 506 being excluded from contending for the wireless medium during the master-sync transmission. In some embodiments the trigger frame may indicate an uplink (UL) UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or non-legacy stations 504 in accordance with legacy IEEE 802.11 communication techniques. In some embodiments, the AP 502 may also be configurable to communicate with STAs 504 outside the TXOP in accordance with legacy IEEE 802.11 communication techniques, although this is not a requirement.

In some embodiments station 504 may be a “group owner” (GO) for peer-to-peer modes of operation. A wireless device may be a station 504 or a AP 502.

In some embodiments, the station 504 and/or AP 502 may be configured to operate in accordance with IEEE 802.11mc. In example embodiments, the radio architecture of FIG. 1 is configured to implement the station 504 and/or the AP 502. In example embodiments, the front-end module circuitry of FIG. 2 is configured to implement the station 504 and/or the AP 502. In example embodiments, the radio IC circuitry of FIG. 3 is configured to implement the station 504 and/or the AP 502. In example embodiments, the base-band processing circuitry of FIG. 4 is configured to implement the station 504 and/or the AP 502.

In example embodiments, the Stations 504, AP 502, an apparatus of the Stations 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein.

In example embodiments, the station 504 and/or the AP 502 are configured to perform the methods and operations/functions described herein. In example embodiments, an apparatus of the station 504 and/or an apparatus of the AP 502 are configured to perform the methods and functions described herein. The term Wi-Fi may refer to one or more of the IEEE 802.11 communication standards. AP and STA may refer to access point 502 and/or station 504 as well as legacy devices 506.

In some embodiments, the AP and STAs may communicate in accordance with one of the IEEE 802.11 standards including IEEE Std 802.11-2020, IEEE P802.11ax/D8.0, October 2020, IEEE P802.11REVmd/D5.0, IEEE P802.11be/D3.0, January 2023 and IEEE P802.11-REVme/D1.3.

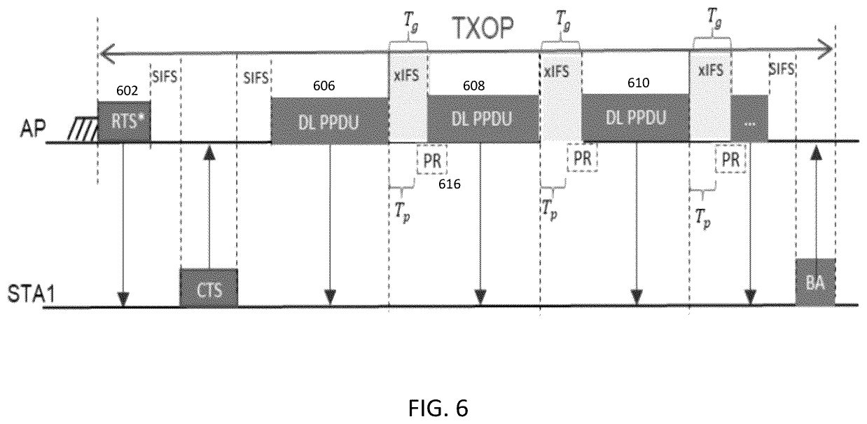

Embodiments disclosed herein relate to preemption for support low-latency applications, particularly for next-generation WLANs including WiFi 8. FIG. 6 illustrates preemption for low-latency (LL) traffic during a transmission opportunity (TXOP), in accordance with some embodiments.

Some embodiments are directed to an access point station (AP) configured for ultra-high reliability (UHR) communication in a wireless local area network (WLAN). In these embodiments, when the AP is configured to receive low-latency (i.e., time-sensitive) traffic, the AP may encode an initial frame (e.g., an RTS frame 602 (see FIG. 6)) for transmission. The initial frame may be encoded to indicate whether or not preemption for low-latency (LL) traffic is enabled during a transmission opportunity (TXOP). The TXOP may have been acquired by the AP. In these embodiments, when preemption for LL traffic is enabled (i.e., permitted) during the TXOP, the AP may encode a plurality of downlink (DL) physical-layer protocol data units (PPDUs) 606, 608, 610, etc. for transmission within the TXOP. The DL PPDUs may be transmitted with an extended short interframe spacing (xIFS) therebetween. Each of the DL PPDUs may be encoded to indicate whether the xIFS that follows a DL PPDU is enabled for preemption.

In these embodiments, when a signal comprising at least a legacy short-training field (L-STF) is detected within one of the xIFSs that is enabled for preemption, the AP may suspend a subsequent transmission of at least the next DL PPDU 608 and may attempt to decode a frame that comprises the L-STF to determine if the frame is a preemption request frame 616. In these embodiments, the AP may trigger a station (STA) to transmit LL traffic to the AP when the frame is determined to be a preemption request frame 616.

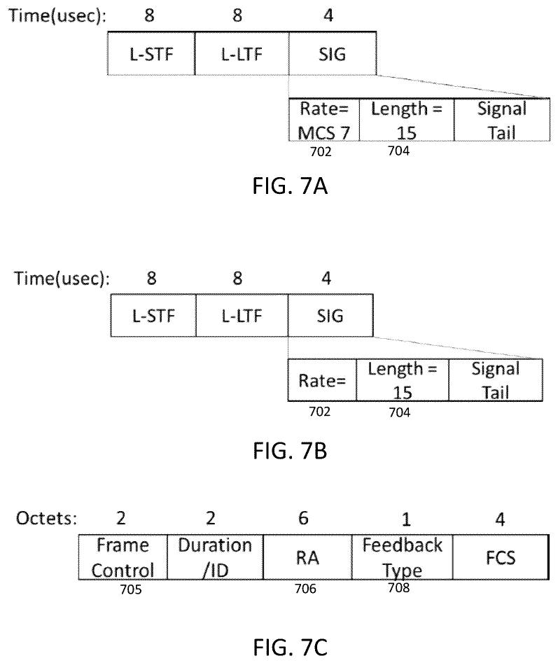

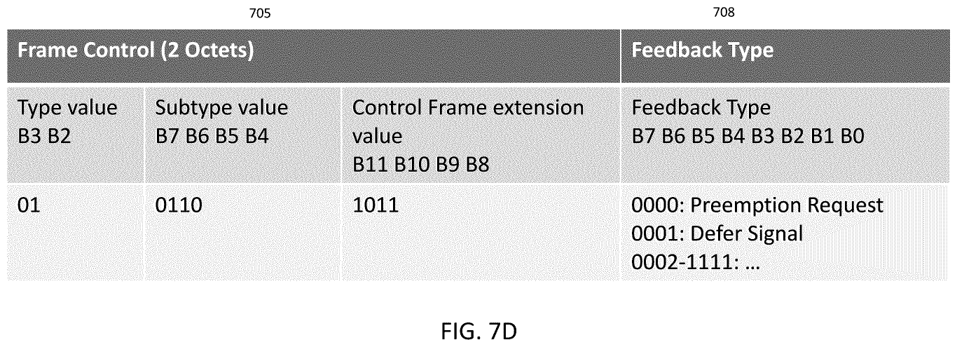

In these embodiments, the preemption request frame 616 may comprise a preamble comprising at least one or more training fields (e.g., an L-STF and L-LTF) including the L-STF followed by a signal (SIG) field. The SIG field may have a predetermined length value in a length field 704 (e.g., length=15) (see FIG. 7A) to indicate that the frame is a preemption request frame 616.

An example of these embodiments is illustrated in FIG. 6. In these embodiments, the AP may indicate whether preemption is allowed within the xIFS after the SIFS following the end of the current DL PPDU. However, the AP may only be able to detect the STF and possibly a LTF of a frame during the SIFS to PIFS time before it starts to send the next DL PPDU. Accordingly, when the AP detects a STF within a PIFS, the AP may suspend transmission of the following DL PPDU. If the frame is determined to be a preemption request frame, the AP can determine whether to trigger STAs to send uplink LL packets. In these embodiments, the AP may not be able to determine whether the frame is preemption request frame or not, since the Tp time is around SIFS and Tg time is PIFS. Accordingly, once the AP detects the STF within a PIFS time before it sends the next scheduled PPDU, it shall suspend the next PPDU transmission.

In some embodiments, the AP may be configured to suspend the subsequent transmission of at least the next DL PPDU 608 when only an initial portion of the preemption request frame 616 is received within the xIFS after a predetermined time (Tp) after a start of the xIFS. The predetermined time (Tp) may be less than the xIFS (Tg). In these embodiments, a remaining portion of the preemption request frame 616 may be received after an end the xIFS (i.e., after Tg).

In some embodiments, predetermined time (Tp) may be an SIFS. The SIFS may be 10 microseconds, although the scope of the embodiments is not limited in this respect. In some embodiments, the xIFS (Tg) may be about a point coordination function (PCF) interframe space (PIFS). The PIFS may be 30 microseconds (long slot time for 2.5 GHz operation), 19 microseconds (short slot time for 2.5 GHz operation) and 25 microseconds (for 5 GHz operation), although the scope of the embodiments is not limited in this respect.

In some embodiments, the AP may be configured to suspend the subsequent transmission of at least the next DL PPDU 608 when all portions of the preemption request frame 616 are received within the xIFS after the predetermined time (Tp). In these embodiments, when all portions of the preemption request frame 616 are received are received within the xIFS after the predetermined time (Tp), the preemption request frame 616 may be configured in accordance with a short waveform design. In these embodiments, the entire preemption request frame 616 may be received and detected with a short timeframe (i.e., Tg-Tp) which is before the start of the next DL PPDU transmission. In these embodiments, a STA with LL traffic may be able to transmit a preemption request frame within time Tg-Tp using a short waveform design. The shorter waveform design allows the preemption request frame to be transmitted within a short time (i.e., Tg-Tp), although the scope of the embodiments is not limited in this respect.

In some embodiments, the predetermined length value encoded the SIG field is fifteen (15), although the scope of the embodiments is not limited in this respect.

In some embodiments, when neither a L-STF is received within the xIFS after the predetermined time (Tp) nor a preemption request frame 616 is received within the xIFS after the predetermined time (Tp), the AP may refrain from suspending the subsequent transmission of the next DL PPDU 608, although the scope of the embodiments is not limited in this respect.

In some embodiments, the preemption request frame 616 may be encoded in accordance with a first frame format that comprises only the preamble comprising the one or more training fields and the SIG field and may be devoid of any additional fields including a data field or data symbols. In these embodiments, the preemption request frame 616 may be devoid of a receiver address (RA) that identifies a station transmitting the preemption request frame 616. In some of these embodiments, the preemption request frame may comprise only a PHY preamble. An example of this first frame format is shown in FIG. 7A and FIG. 7B. It should be noted that in these embodiments, the AP is unable to identify the particular station that has sent the preemption request frame.

In some embodiments, the AP may be configured to determine that the frame is a preemption request frame 616 when the SIG field has the predetermined length value in the length field 704 and when the SIG field has a predetermined rate value in a rate field 702 indicating a highest supported data rate (e.g., MCS=7). An example of this is shown in FIG. 7A.

In some of these embodiments, the predetermined length value is fifteen (15) and the predetermined rate value is MCS=7 indicating a highest supported data rate, although the scope of the embodiments is not limited in this respect. In some of these embodiments, the preamble may comprise a known signal comprising a legacy IEEE 802.11a preamble without data symbols in which the length field and MCS field are set to predefined values unused in IEEE 802.11a. In these embodiments, the value of length field may be predetermined or defined. For example, the length field may be set to 0 or some value between 0 and 15. The value of the rate field (i.e., the MCS) may also be predetermined or defined. For example, the MCS may be picked between 0 and 7. Accordingly, a legacy device will fail the frame check sequence (FCS).

In some alternate embodiments, the preemption request frame 616 may further comprise a data portion following the preamble. In these alternate embodiments, the data portion may be configured in accordance with a short feedback medium access control (MAC) frame format that includes a frame control field 705, a receiver address (RA) field 706 and a feedback type field 708. In these embodiments, the frame control field 705 may include a type value, a subtype value, and a control frame extension value. In these embodiments, the AP may determine that the frame is a preemption request frame 616 based on a combination of the type value, the subtype value, and the control frame extension and a value of the feedback type field 708, although the scope of the embodiments is not limited in this respect. An example of the short feedback MAC frame format is illustrated in FIG. 7C and an example of the frame control and feedback type field is illustrated in FIG. 7D.

In some embodiments, the DL PPDUs are transmitted to a first station (STA1). In these embodiments, the preemption request frame 616 may be received from the first station (STA1) or a second station (STA2). In these embodiments, when the AP suspends transmission of the next DL PPDU 608, the AP may decode a LL transmission received from the first station or the second station within the TXOP. In these embodiments, the LL transmission may comprise LL traffic.

In these embodiments, either the station receiving the DL PPDUs (i.e., STA1) can transmit a preemption request frame 616 or another station (i.e., STA2) can transmit a preemption request frame 616. When the preemption request frame 616 is received from the first station, it is the first station that is preempting transmission of DL PPDUs to itself. When the preemption request frame 616 is received from another station (i.e., STA2), it is the other station that is preempting the transmission of DL PPDUs to the first station.

In some embodiments, to trigger a STA to transmit the LL traffic when the frame is determined to be a preemption request frame 616 and when the AP suspends transmission of the next DL PPDU 608, the AP may encode a null-data packet (NDP) feedback report (NFR) for transmission to trigger one or more LL STAs to report a buffer stations, although the scope of the embodiments is not limited in this respect. In these embodiments, the AP may decode the LL traffic received on previously allocated resources from the one or more LL STAs during the TXOP.

In some embodiments, when the frame is determined to be a preemption request frame 616 and when the AP suspends transmission of the next DL PPDU 608, the AP may trigger one or more LL STAs to transmit the LL traffic during the TXOP in accordance with an uplink orthogonal frequency division multiple access (UL OFDMA) based random access technique, although the scope of the embodiments is not limited in this respect.

In some other embodiments, for reception of the LL traffic when the frame is determined to be a preemption request frame 616, the AP may suspend transmission of the next DL PPDU 608 and terminate the TXOP to release the channel to allow for the transmission of the LL traffic by one or more LL STAs in accordance with an enhanced distributed channel access (EDCA) technique, although the scope of the embodiments is not limited in this respect.

In some embodiments, when the initial frame is encoded to indicate that preemption for LL traffic is not enabled during the TXOP, the AP may encode an aggregated MPDU (A-MPDU) for transmission during the TXOP. In these embodiments, the A-MPDU may comprise the plurality of DL PPDUs. In these embodiments, when the LL traffic is not enabled during the TXOP, no xIFSs are available since an A-MPDU may be transmitted instead of multiple DL PPDUs. On the other hand, when the AP wishes to enable preemption for LL traffic during the TXOP, downlink traffic which would be transmitted in an A-MPDU, can be transmitted in multiple DL PPDUs to allow for the inclusion of the xIFS between the DL PPDUs.

In some embodiments, the AP may be configured to refrain from triggering a station (STA) to transmit LL traffic when the frame is determined a control frame that is not a preemption request frame 616.

Some embodiments are directed to a non-transitory computer-readable storage medium that stores instructions for execution by processing circuitry of an access point station (AP) configured for ultra-high reliability (UHR) communication in a wireless local area network (WLAN). In these embodiments, when the AP may be configured to receive low-latency (i.e., time-sensitive) traffic and may encode an initial frame (e.g., an RTS frame 602 (see FIG. 6)) for transmission that may be encoded to indicate whether or not preemption for low-latency (LL) traffic is enabled during a transmission opportunity (TXOP). The TXOP may have been acquired by the AP. In these embodiments, when preemption for LL traffic is enabled (i.e., permitted) during the TXOP, the AP may encode a plurality of downlink (DL) physical-layer protocol data units (PPDUs) 606, 608, 610, etc. for transmission within the TXOP. The DL PPDUs may be transmitted with an extended short interframe spacing (xIFS) therebetween. Each of the DL PPDUs may be encoded to indicate whether the xIFS that follows a DL PPDU is enabled for preemption.

Some embodiments are directed to a non-access point station (STA) configured for ultra-high reliability (UHR) communication in a wireless local area network (WLAN). In these embodiments, when the STA is configured to transmit low-latency (i.e., time-sensitive) traffic, the STA may decode an initial frame (e.g., an RTS frame 602 (see FIG. 6)) received from an access point (AP). The initial frame may indicate whether or not preemption for low-latency (LL) traffic is enabled during a transmission opportunity (TXOP) acquired by the AP. In these embodiments, when preemption for LL traffic is enabled during the TXOP, the STA may decode at least an initial portion of one or more of a plurality of downlink (DL) physical-layer protocol data units (PPDUs) 606, 608, 610, etc. that are transmitted by the AP within the TXOP to determine if preemption is enabled within an extended short interframe spacing (xIFS) that follows one of the DL PPDUs. When the STA has LL traffic available for transmission, the STA may encode a preemption request frame for transmission to the AP during one of the xIFSs that are indicated as being enabled for preemption. In these embodiments, the STA may receive a trigger from the AP to trigger transmission of the LL traffic in the TXOP. In these embodiments, the STA may transmit at least a legacy short-training field (L-STF) of the preemption request frame is within the xIFS after a predetermined time (Tp) after a start of the xIFS. As illustrated in FIG. 6, the predetermined time (Tp) is less than the xIFS (Tg).

In some embodiments, the STA may encode the preemption request frame 616 to include a preamble comprising at least one or more training fields (e.g., an L-STF and L-LTF) including the L-STF followed by a signal (SIG) field. The SIG field may have a predetermined length value in a length field 704 (e.g., length=15) (see FIG. 7A) to indicate that the frame is a preemption request frame 616.

In these embodiments, a large PPDU may be into small PPDUs with maximum length limitation and time gaps to enable preemption opportunity for LL transmitter. In these embodiments, one or more LL stations (STAs) (i.e., LL transmitters) can start to send a common preemption request (PR) during the time gaps to indicate that it has LL packet to send when the preemption is allowed. This may help avoid collisions among multiple LL transmitters and may help avoid reserving time slot periodically within TXOP for LL traffic. The PR frame can be transmitted within Tₐ before the next PPDU.

In these embodiments, to prioritize a LL transmitter, a shorter xIFS) (T_{P}) channel access may be used for the LL transmitter (T_{P}) to send common PR comparing with the Tₐ for the TXOP holder (Tₐ) to send data/TF/BA as shown in FIG. 6. Note: T_{P}<Tₐ. In these embodiments, a PR frame can only be sent before the next PPDU from the AP to avoid hidden node problem between STAs, which means STA cannot preempt STA directly. Upon the reception of the common PR, the AP may use the following different methods to support the LL packet transmission.

In some embodiments, the AP may trigger the LL STAs to feedback the LL buffer status using NFRP, then trigger the LL data transmission. The trigger for the LL STAs' feedback may be implicit such that the LL STAs may send the feedback (e.g., via NFR or OFDMA random access) directly without the common PR and the feedback trigger or may send the feedback (e.g., via NFR) with the common PR but without the feedback trigger. In these cases, the AP may allocate the frequency resources (e.g., the subcarrier sets) to the LL STAs beforehand.

In some embodiments, the AP may trigger the LL STAs to send LL packets with uplink OFDMA-based random access. The trigger for the LL STAs' uplink may be implicit such that the LL STAs can send the uplink directly without the common PR and the uplink trigger; or send the uplink with the common PR but without the uplink trigger. In these embodiments, the AP may allocate the frequency resources (e.g., the OFDMA RUs) to the LL STAs beforehand.

In some other embodiments, the AP may terminate the TXOP early and release the channel for LL transmission with EDCA, although the scope of the embodiments is not limited in this respect.

FIG. 7A illustrates a preemption request control frame, in accordance with some embodiments. FIG. 7B illustrates a preemption request control frame, in accordance with some other embodiments. In some of these embodiments, a Preemption request control frame may be indicated by combination of the Rate and the length field in the PHY preamble. One example is to use the highest supported data rate MCS 7 and the unused length field value of 15. In these embodiments, the PSDU will be packaged with dumping packet. For the legacy mode user, upon reception of this preemption request frame, it will deal with it as wrong PSDU after a FCS check error. For a new device which is the current TXOP holder and can decode this new preemption request control frame, it will suspend the following PPDU transmission.

FIG. 7C illustrates Short Feedback MAC frame format for a preemption request frame, in accordance with some embodiments. In these embodiments, the length field in the preamble equal to 15. The short feedback MAC frame is constructed with Frame Control (2 bytes), Duration/ID (2 bytes), RA (6 bytes), Feedback Type (2 bytes) and FCS (4 bytes). The Preemption request control frame will be indicated by the combination of the Type, Subtype, control frame extension and Feedback type fields as shown in above table. Note, this short new feedback MAC frame format may be extended to support other functionality, such as MCS adjustment or SNR feedback for link adaptation, by using the rest of feedback type field values (0001-1111). FIG. 7D illustrates frame control and feedback time fields, in accordance with some embodiments.

In some embodiments, since only the LL STAs are allowed by the AP to send the PR within T_{P} (i.e., before all other devices) the AP can assume the received PPDU within T_{P} is from the designated LL STA. Therefore, there may be no need for the PSDU. Namely, a signal known to the AP will work. For example, the known signal can a legacy 802.11a preamble without data symbols as shown in FIG. 7A and FIG. 7B. The value setting of length field can be defined in the spec. For example, the length field may be set to 0 or some value between 0 and 15. The value setting of the MCS can be defined in the spec as well. For example, the MCS may be picked between 0 and 7. Legacy device will fail the FCS.

In some embodiments, the unusable length value 15 may be used to indicate a preemption request frame. Similarly, the MCS settings unused by 802.11a can be used for indicating a preemption request frame. For example, 0000, 0010, and other six values are unused by 802.11a and can be used for indicating a preemption request frame.

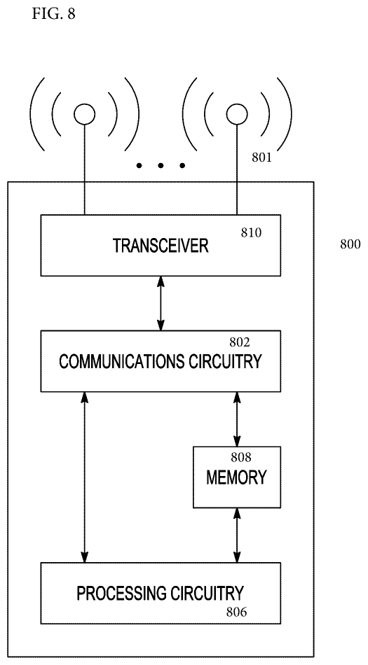

FIG. 8 illustrates a functional block diagram of a wireless communication device, in accordance with some embodiments. In one embodiment, FIG. 8 illustrates a functional block diagram of a communication device (STA) that may be suitable for use as an AP STA, a non-AP STA or other user device in accordance with some embodiments. The wireless communication device 800 may also be suitable for use as a handheld device, a mobile device, a cellular telephone, a smartphone, a tablet, a netbook, a wireless terminal, a laptop computer, a wearable computer device, a femtocell, a high data rate (HDR) subscriber device, an access point, an access terminal, or other personal communication system (PCS) device.

The wireless communication device 800 may include communications circuitry 802 and a transceiver 810 for transmitting and receiving signals to and from other communication devices using one or more antennas 801. The communications circuitry 802 may include circuitry that can operate the physical layer (PHY) communications and/or medium access control (MAC) communications for controlling access to the wireless medium, and/or any other communications layers for transmitting and receiving signals. The wireless communication device 800 may also include processing circuitry 806 and memory 808 arranged to perform the operations described herein. In some embodiments, the communications circuitry 802 and the processing circuitry 806 may be configured to perform operations detailed in the above figures, diagrams, and flows.

In accordance with some embodiments, the communications circuitry 802 may be arranged to contend for a wireless medium and configure frames or packets for communicating over the wireless medium. The communications circuitry 802 may be arranged to transmit and receive signals. The communications circuitry 802 may also include circuitry for modulation/demodulation, upconversion/downconversion, filtering, amplification, etc. In some embodiments, the processing circuitry 806 of the wireless communication device 800 may include one or more processors. In other embodiments, two or more antennas 801 may be coupled to the communications circuitry 802 arranged for sending and receiving signals. The memory 808 may store information for configuring the processing circuitry 806 to perform operations for configuring and transmitting message frames and performing the various operations described herein. The memory 808 may include any type of memory, including non-transitory memory, for storing information in a form readable by a machine (e.g., a computer). For example, the memory 808 may include a computer-readable storage device, read-only memory (ROM), random-access memory (RAM), magnetic disk storage media, optical storage media, flash-memory devices and other storage devices and media.

In some embodiments, the wireless communication device 800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the wireless communication device 800 may include one or more antennas 801. The antennas 801 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the wireless communication device 800 may include one or more of a keyboard, a display, a non-volatile memory port, multiple antennas, a graphics processor, an application processor, speakers, and other mobile device elements. The display may be an LCD screen including a touch screen.

Although the wireless communication device 800 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the wireless communication device 800 may refer to one or more processes operating on one or more processing elements.

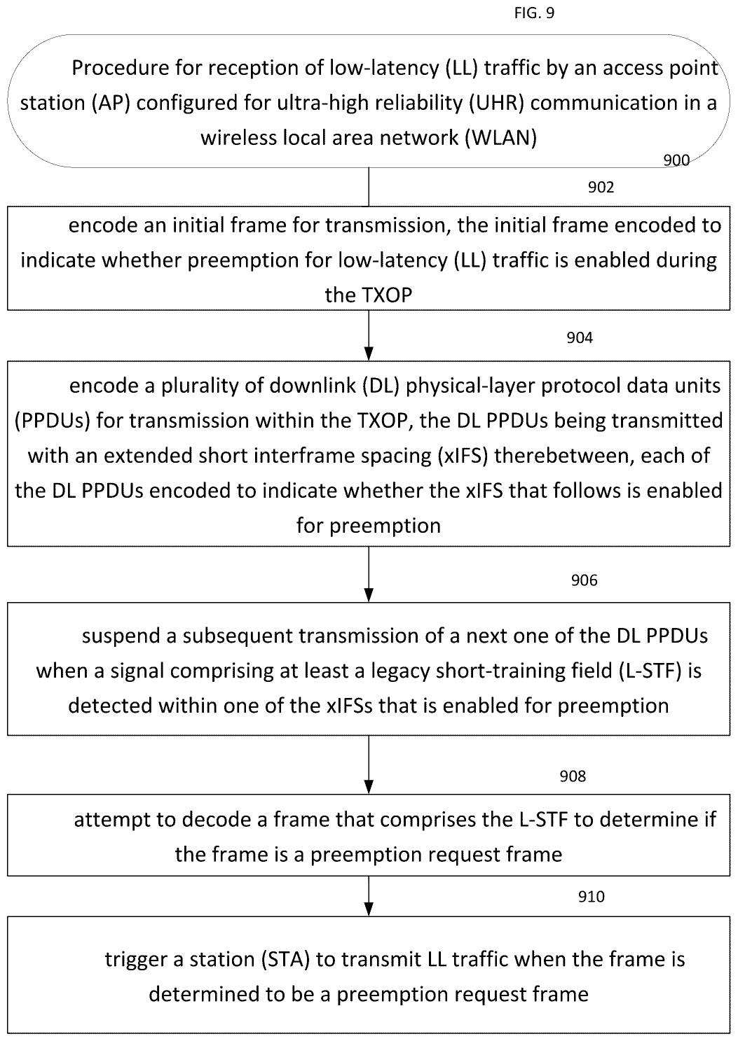

FIG. 9 is a procedure 900 for reception of low-latency (LL) traffic by an access point station (AP) configured for ultra-high reliability (UHR) communication in a wireless local area network (WLAN), in accordance with some embodiments.

In operation 902, the AP may encode an initial frame for transmission. The initial frame may be encoded to indicate whether preemption for low-latency (LL) traffic is enabled during the TXOP.

In operation 904, the AP may encode a plurality of downlink (DL) physical-layer protocol data units (PPDUs) for transmission within the TXOP. The DL PPDUs may be transmitted with an extended short interframe spacing (xIFS) therebetween. Each of the DL PPDUs may be encoded to indicate whether the xIFS that follows is enabled for preemption.

In operation 906, the AP may suspend a subsequent transmission of a next one of the DL PPDUs when a signal comprising at least a legacy short-training field (L-STF) is detected within one of the xIFSs that is enabled for preemption.

In operation 908, the AP may attempt to decode a frame that comprises the L-STF to determine if the frame is a preemption request frame.

In operation 910, the AP may trigger a station (STA) to transmit LL traffic when the frame is determined to be a preemption request frame.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an access point station (AP) configured for ultra-high reliability (UHR) communication in a wireless local area network (WLAN), the apparatus comprising: processing circuitry; and memory, wherein the processing circuitry is configured to:
encode an initial frame for transmission, the initial frame encoded to indicate whether preemption for low-latency (LL) traffic is enabled during a transmission opportunity (TXOP);
wherein when preemption for LL traffic is enabled during the TXOP, the processing circuitry is configured to:
encode a plurality of downlink (DL) physical-layer protocol data units (PPDUs) for transmission within the TXOP, the DL PPDUs being transmitted with an extended short interframe spacing (xIFS) therebetween, each of the DL PPDUs encoded to indicate whether the xIFS that follows is enabled for preemption; and
when a signal comprising at least a legacy short-training field (L-STF) is detected within one of the xIFSs that is enabled for preemption, the processing circuitry is configured to:
suspend a subsequent transmission of a next one of the DL PPDUs;
attempt to decode a frame that comprises the L-STF to determine if the frame is a preemption request frame; and
trigger a station (STA) to transmit LL traffic when the frame is determined to be a preemption request frame,
wherein the preemption request frame comprises a preamble comprising at least one or more training fields including the L-STF followed by a signal (SIG) field, the SIG field having a predetermined length value in a length field to indicate that the frame is a preemption request frame.

2. The apparatus of claim 1, wherein the processing circuitry is configured to suspend the subsequent transmission of the next DL PPDU when an initial portion of the preemption request frame is received within the xIFS after a predetermined time (Tp) after a start of the xIFS, the predetermined time (Tp) being less than the xIFS, and
wherein a remaining portion of the preemption request frame is received after an end the xIFS.

3. The apparatus of claim 2, wherein the processing circuitry is configured to suspend the subsequent transmission of the next DL PPDU when all portions of the preemption request frame are received within the xIFS after the predetermined time (Tp),
wherein when all portions of the preemption request frame are received are received within the xIFS after the predetermined time (Tp), the preemption request frame is configured in accordance with a short waveform design.

4. The apparatus of claim 3 wherein the predetermined length value encoded the SIG field is fifteen (15).

5. The apparatus of claim 4, wherein when neither a L-STF is received within the xIFS after the predetermined time (Tp) nor a preemption request frame is received within the xIFS after the predetermined time (Tp), the processing circuitry is configured to refrain from suspending the subsequent transmission of the next DL PPDU.

6. The apparatus of claim 5, wherein the preemption request frame is encoded in accordance with a first frame format that comprises the preamble comprising the one or more training fields and the SIG field and is devoid of a data field, the preemption request frame being devoid of a receiver address that identifies a station transmitting the preemption request frame.

7. The apparatus of claim 6, wherein the processing circuitry is configured to determine that the frame is a preemption request frame when the SIG field has the predetermined length value in the length field and when the SIG field has a predetermined rate value in a rate field.

8. The apparatus of claim 5, wherein the preemption request frame further comprises a data portion following the preamble, the data portion configured in accordance with a short feedback medium access control (MAC) frame format that includes a frame control field, a receiver address (RA) field and a feedback type field, the frame control field including a type value, a subtype value, and a control frame extension value, and
wherein the processing circuitry is configured to determine that the frame is a preemption request frame based on a combination of the type value, the subtype value, and the control frame extension and a value of the feedback type field.

9. The apparatus of claim 5, wherein the DL PPDUs are transmitted to a first station (STA1) and wherein the preemption request frame is received from one of the first station (STA1) and a second station (STA2), and
wherein when the processing circuitry suspends transmission of the next DL PPDU, the processing circuitry is configured to decode a LL transmission received from one of the first station and the second station within the TXOP, the LL transmission comprising the LL traffic.

10. The apparatus of claim 5, wherein to trigger a STA to transmit the LL traffic when the frame is determined to be a preemption request frame and when the processing circuitry suspends transmission of the next DL PPDU, the processing circuitry is configured to:
encode a null-data packet (NDP) feedback report (NFR) for transmission to trigger one or more LL STAs to report a buffer stations; and
decode the LL traffic received on allocated resources from the one or more LL STAs during the TXOP.

11. The apparatus of claim 5, wherein when the frame is determined to be a preemption request frame and when the processing circuitry suspends transmission of the next DL PPDU, the processing circuitry is configured to trigger one or more LL STAs to transmit the LL traffic during the TXOP in accordance with an uplink orthogonal frequency division multiple access (UL OFDMA) based random access technique.

12. The apparatus of claim 5, wherein for reception of the LL traffic when the frame is determined to be a preemption request frame, the processing circuitry is configured to suspend transmission of the next DL PPDU and terminate the TXOP to release the TXOP to allow for the transmission of the LL traffic by one or more LL STAs in accordance with an enhanced distributed channel access (EDCA) technique.

13. The apparatus of claim 5, wherein when the initial frame is encoded to indicate that preemption for LL traffic is not enabled during the TXOP, the processing circuitry is configured to encode an aggregated MPDU (A-MPDU) for transmission during the TXOP, the A-MPDU comprising the plurality of DL PPDUs.

14. The apparatus of claim 1, wherein the processing circuitry is configured to refrain from triggering the station (STA) to transmit LL traffic when the frame is determined to be a control frame that is not a preemption request frame.

15. A non-transitory computer-readable storage medium that stores instructions for execution by processing circuitry of an access point station (AP) configured for ultra-high reliability (UHR) communication in a wireless local area network (WLAN), wherein the processing circuitry is configured to:
encode an initial frame for transmission, the initial frame encoded to indicate whether preemption for low-latency (LL) traffic is enabled during a transmission opportunity (TXOP);
wherein when preemption for LL traffic is enabled during the TXOP, the processing circuitry is configured to:
encode a plurality of downlink (DL) physical-layer protocol data units (PPDUs) for transmission within the TXOP, the DL PPDUs being transmitted with an extended short interframe spacing (xIFS) therebetween, each of the DL PPDUs encoded to indicate whether the xIFS that follows is enabled for preemption; and
when a signal comprising at least a legacy short-training field (L-STF) is detected within one of the xIFSs that is enabled for preemption, the processing circuitry is configured to:
suspend a subsequent transmission of a next one of the DL PPDUs;
attempt to decode a frame that comprises the L-STF to determine if the frame is a preemption request frame; and
trigger a station (STA) to transmit LL traffic when the frame is determined to be a preemption request frame,
wherein the preemption request frame comprises a preamble comprising at least one or more training fields including the L-STF followed by a signal (SIG) field, the SIG field having a predetermined length value in a length field to indicate that the frame is a preemption request frame.

16. The non-transitory computer-readable storage medium of claim 15,
wherein the processing circuitry is configured to suspend the subsequent transmission of the next DL PPDU when an initial portion of the preemption request frame is received within the xIFS after a predetermined time (Tp) after a start of the xIFS, the predetermined time (Tp) being less than the xIFS, and wherein a remaining portion of the preemption request frame is received after an end the xIFS.

17. The non-transitory computer-readable storage medium of claim 16, wherein the processing circuitry is configured to suspend the subsequent transmission of the next DL PPDU when all portions of the preemption request frame are received within the xIFS after the predetermined time (Tp),
wherein when all portions of the preemption request frame are received are received within the xIFS after the predetermined time (Tp), the preemption request frame is configured in accordance with a short waveform design.

18. The non-transitory computer-readable storage medium of claim 17 wherein the predetermined length value encoded the SIG field is fifteen (15), and
wherein when neither a L-STF is received within the xIFS after the predetermined time (Tp) nor a preemption request frame is received within the xIFS after the predetermined time (Tp), the processing circuitry is configured to refrain from suspending the subsequent transmission of the next DL PPDU.

19. An apparatus of a non-access point station (STA) configured for ultra-high reliability (UHR) communication in a wireless local area network (WLAN), the apparatus comprising: processing circuitry; and memory, wherein the processing circuitry is configured to:
decode an initial frame received from an access point (AP), the initial frame to indicate whether preemption for low-latency (LL) traffic is enabled during a transmission opportunity (TXOP) acquired by the AP;
wherein when preemption for LL traffic is enabled during the TXOP, the processing circuitry is configured to:
decode at least an initial portion of one or more of a plurality of downlink (DL) physical-layer protocol data units (PPDUs) that are transmitted by the AP within the TXOP to determine if preemption is enabled within an extended short interframe spacing (xIFS) that follows one of the DL PPDUs;
when the STA has LL traffic available for transmission, the processing circuitry is configured to:
encode a preemption request frame for transmission to the AP during one of the xIFSs that are indicated as being enabled for preemption; and
receive a trigger from the AP to trigger transmission of the LL traffic in the TXOP,
wherein the processing circuitry is configured to cause the STA to transmit at least a legacy short-training field (L-STF) of the preemption request frame is within the xIFS after a predetermined time (Tp) after a start of the xIFS, the predetermined time (Tp) being less than the xIFS.

20. The apparatus of claim 19, wherein the processing circuitry is configured to encode the preemption request frame to include a preamble comprising at least one or more training fields including the L-STF followed by a signal (SIG) field, the SIG field having a predetermined length value in a length field to indicate that the frame is a preemption request frame.
